(19) United States
(12) Patent Application Publication
(10) Pub. No.: US 2005/0076293 A1
(43) Pub. Date: Apr. 7, 2005

(54) Document storage

(75) Inventor: Yolanta Beresnevichiene, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/606,770

(22) Filed: Jun. 27, 2003

(30) Foreign Application Priority Data
Jul. 2, 2002 (GB) 0215198.3

(51) Int. Cl. G06F 17/00

(52) U.S. Cl. 715/514

(57) ABSTRACT

The present invention provides a document storage specification generator apparatus (2) for generating a storage specification (14) for a document (10), the document (10) having associated with it at least one storage label (12), the apparatus (2) comprising a storage specification template database (4) for determining storage specification templates according to storage labels associated with documents, a rules database (6) comprising rules for resolving conflicts between conflicting storage specification templates and a storage specification generator (8) for generating a storage specification (14) for the document (10) therefrom. A corresponding method, which may use specification fields, and appropriately programmed computer apparatus is also disclosed.

The present invention relates to document storage specification generator apparatus, to methods for generating document storage specifications, and to programmed computer apparatus for carrying out such methods.

Many organisations produce large amounts of digital documents in the normal course of business. Keeping track of such documents therefore becomes an ever growing problem. One method used to address this problem is to store digital documents in document repositories, such as computer memories or data carriers for computers, with each document having associated with it a label to assign each document to a class from a number of pre-determined document classes. A storage specification is then derived according to the specifics of this class. For instance, a document may have a label assigned according to its document type, which can be selected from
word processing document
spreadsheet document
database document
encrypted document

and the specification template may specify a retention period for the document according to its class, for instance as follows:

| | |
|---|---|
| word processing document | 6 years |
| spreadsheet document | 6 years |
| database document | 3 years |
| encrypted document | 10 years |

Such a method may be suitable when there is a relatively small number of classes and little or no overlap between them. However, in practice, in many business environments there exist numerous types of documents, not always falling within a particular class. This would require a separate storage specification for each document type, which quickly becomes untenable. Further, there is no mechanism to manage overlaps between document specifications.

While in an ideal world overlaps in large organisations could be avoided by all systems administrators ensuring that such specifications do not overlap, in practice this is administratively burdensome and unlikely to occur. Furthermore, it would not address the issue of reconciling storage specifications from different organisations or individuals where such cooperation is even less practicable.

It is, therefore, an aim of preferred embodiments of the present invention to obviate or overcome a disadvantage of the prior art, whether referred to herein or otherwise.

According to the present invention in a first aspect, there is provided a document storage specification generator apparatus for generating a storage specification for a document, the document having associated with it at least one storage label, the apparatus comprising a storage specification template database for determining storage specification templates according to storage labels associated with documents, a rules database comprising rules for resolving conflicts between conflicting storage specification templates and a storage specification generator for generating a storage specification for the document therefrom.

Suitably, the apparatus comprises a hierarchy database having hierarchies of specification templates and the rules database comprises hierarchy rules for reconciling storage specification template conflicts according to the relative storage specification hierarchy.

Suitably, the rules database comprises inter-label storage specification template conflict resolution rules.

Suitably, a storage specification template comprises a plurality of fields.

Suitably, the apparatus is configured whereby the rules database provides default entries for uninstantiated fields in the storage specification template. Alternatively, the apparatus is configured whereby if there is an uninstantiated field in the storage specification template a user query is referred to a user interface.

Suitably, the apparatus is configured whereby if the rules database determines that a conflict between storage specification templates exists, but that no rule is provided to reconcile the conflict, a user query is generated to a user interface.

According to the present invention in a second aspect, there is provided a document storage specification generation method, for generating a storage specification for a document, the document having associated with it at least one storage label, the method comprising the steps of determining at least one storage specification field according to storage labels associated with documents, resolving conflicts between conflicting storage specification fields by applying rules from a rules database and generating a storage specification for the document therefrom.

Suitably, the at least one storage specification field is of a specification template.

Suitably, a hierarchy database having hierarchies of specification templates and the rules database comprises hierarchy rules for reconciling storage specification template conflicts according to the relative storage specification hierarchy.

Suitably, the rules database comprises inter-label storage specification template conflict resolution rules.

Suitably, the hierarchy rules are applied before the inter-label storage specification template conflict resolution rules.

Suitably, a storage specification template comprises a plurality of fields.

Suitably, the rules database provides default entries for uninstantiated fields in the storage specification template. Alternatively, if there is an uninstantiated field in the storage specification template a user query is referred to a user interface.

Suitably, if it is determined that a conflict between storage specification templates exists, but that no rule is provided to reconcile the conflict, a user query is generated to a user interface.

Suitably, a storage specification for the document is output and associated with the document. According to the present invention in a third aspect, there is provided a computer apparatus programmed to operate according to the method of the second aspect of the present invention.

The present invention will now be described, by way of example only, with reference to the Figures that follow; in which:

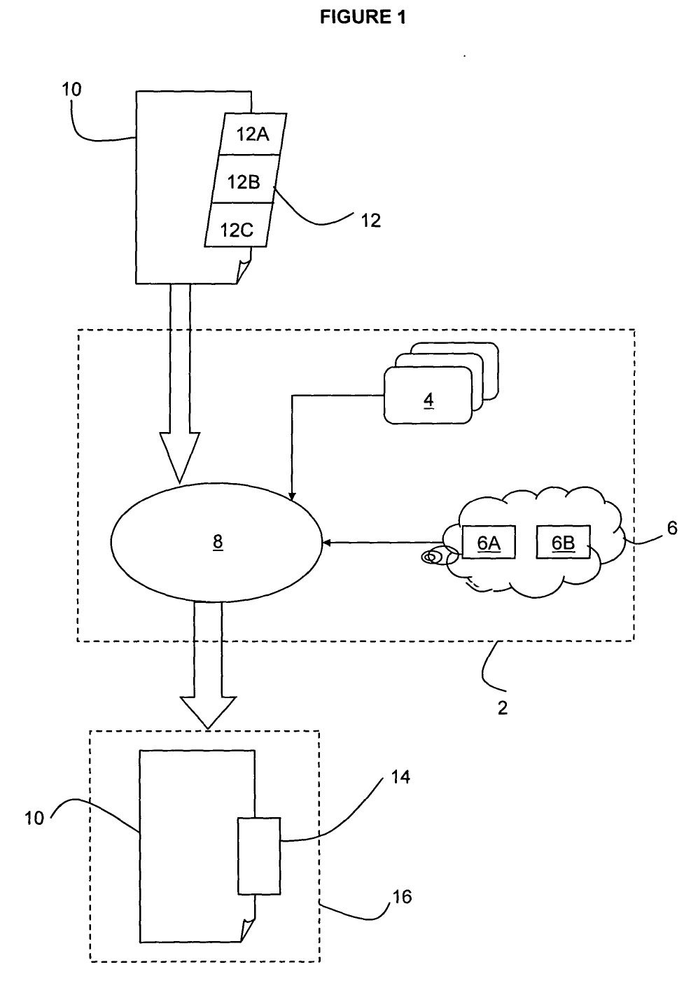

FIG. 1 is a schematic functional illustration of an apparatus according to an embodiment of the present invention.

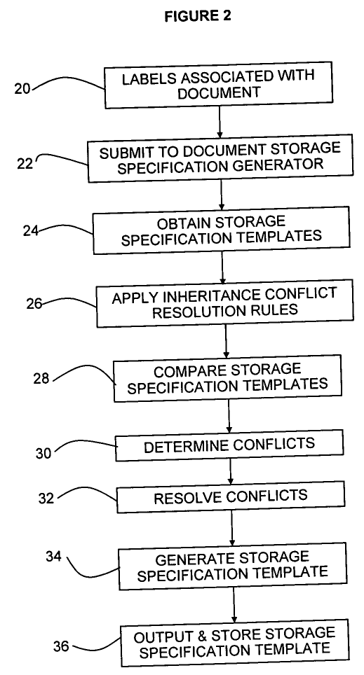

FIG. 2 is a functional flow diagram illustrating a method of an embodiment of the present invention using the FIG. 1 apparatus.

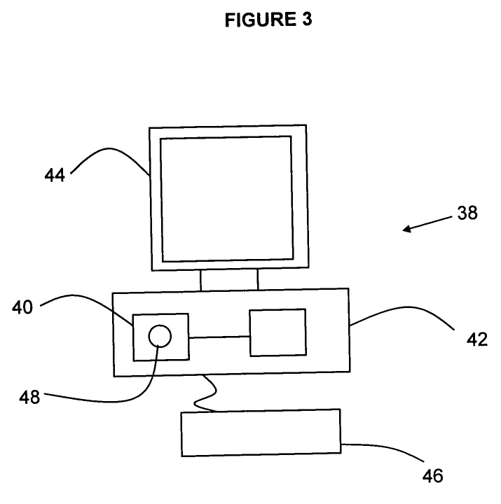

FIG. 3 is a schematic illustration of a computer apparatus for use with the present invention.

Referring to FIG. 1 of the drawings that follow, there is shown a document storage specification generator apparatus 2 comprising a storage specifications template database 4, a rules database 6 and a storage specification generator 8. Rules database 6 contains hierarchy rules 6A and inter-label conflict resolution rules 6B. Each of the storage specification templates database 4 and rules database 6 is in communication with storage specification generator 8.

Also shown in FIG. 1 is a representation of a digital document 10 which, by way of example, could be a MICROSOFT WORD™ document, a drawing, data for a database or any other digital document. Typically when it is ready for storage, but optionally at any time during the lifetime of the digital document 10, it has attached to it a number of labels indicated in FIG. 1 by references 12A, 12B and 12C, and collectively by reference numeral 12.

The output of document storage specification generator 2 is a storage specification 14 associated with document 10, which generally is stored in a document repository indicated by reference numeral 16.

Referring now to FIG. 2 of the drawings that follow, there is shown a functional flow diagram illustrating a method of operation of the apparatus 2 according to the present invention.

In step 20 the labels 12 are associated with document 10 by a user (not shown). The labels 12 may be stored separately from document 10 with a cross-reference thereto, but generally it is more convenient for them to be stored as part of the indexing of document 10.

The labels 12 associated with digital document 10 can, for instance, relate to characteristics of its origin, generation and/or ownership.

A document 10 may have any number of labels 12 associated with it, though in this example three labels 12A, 12B, 12C are used. The first label 12A indicates the business context of the document 10 (e.g. HP Labs, HP Research or HP Corporate), the second label 12B indicates whether the document is PUBLIC or CONFIDENTIAL and the third label 12C indicates the document type (e.g. technical report, conference paper, invention submission, business proposal, memo etc.

In step 22 of FIG. 2, the document 10 and associated labels 12 are submitted to document storage specification generator 2 and in step 24 storage specification templates for the labels 12 associated with document 10 are obtained from storage specification template database 4.

Associated with each label 12A, 12B, 12C is a storage specification template in storage specification template database 4. A storage specification template incorporates a standard internal structure in which a plurality of fields is specified. For a specific label 12A, 12B or 12C, generally only certain fields in the storage specification template are instantiated with some value (which need not be a numerical value).

By way of example the following fields may be available in a document storage template:
1. Retention (Value=number of years)
2. Access control (Value=public, HP Labs, HP Corporate, HP, HP and specified third party)
3. Number of replications (Value=number)
4. Encryption (Value=none, password, RSA)

In step 26 rules database 6 resolves conflicts that can arise in relation to the specification template hierarchy by applying inheritance conflict resolution rules from hierarchy rules 6A. A given template specification can be part of a hierarchical template specification structure. Hierarchy rules 6A include a hierarchy database detailing which templates fall above or below another given template in a hierarchy. Generally this will relate to the business context label 12A, but other hierarchies can exist. In this case, for instance a specification template generated from a label 12A with HP Labs as the business context may form part of a specification template hierarchy with HP Research and HP Corporate, respectively, specification templates above it. Again, the comparison between specification templates is made, conflicts are determined and hierarchy rules 6A are invoked to resolve such conflicts as described above. Generally, hierarchy rules 6A will provide that the relevant field corresponding to a specification template higher in the hierarchy will prevail, but this need not always be the case. For instance, it may be specified that retention period shall always be the longest in any relevant template specification. Similar considerations apply to, for instance, an encryption key length whereby the longest defined in a particular hierarchy chain will, generally, be used.

It is noted that conflicts between hierarchy levels can be resolved without first identifying whether a conflict exists. The hierarchy rules 6A can be used simply to overwrite any conflicts.

In step 28, and after any hierarchical conflicts have been resolved, rules database 6 compares the storage specification templates relevant to labels 12 with one another and determines whether any conflicts arise (step 30). Some of the initial storage specification templates may have been overridden by the hierarchy conflict resolution. This is a determination of inter-label storage specification template conflict. Rules database 6 contains inter-label storage specification template conflict resolution rules 6B to deal with such conflicts.

Thus, by way of example, if the business context label 12A is HP Labs the corresponding storage specification template for that label may indicate that those documents are to be retained for three years and access control shall be restricted to HP Labs, with RSA encryption. However, if the label 12B is “CONFIDENTIAL” the retention may be for four years, access control is to HP Labs and a given third party, and there is no encryption specified. Thus between the storage specification template for labels 12A and 12B there are conflicts in terms of retention period (three years as opposed to four years), access control (HP Labs as opposed to HP Labs and a specified third party) and encryption (RSA as opposed to none). The inter-label storage specification conflict rules 6B specify what happens when these conflicts arise. For instance, for conflicts in relation to retention the relevant conflict rule may be that the document retention is specified as the longest period in any template; access control may default to the most restricted access and encryption may default to the most secure specified in any relevant specification template.

It will be appreciated that the actual conflict resolution rules in any given application are a matter of choice for the designer.

These are merely examples of the many conflicts that could arise.

Generally, rules database 6 will determine that a conflict exists between two storage specification templates if for the same field a different value is present in another relevant specification template; relevant specification templates being either inter-label specification templates or hierarchical specification templates. However, more complex conflict rules may be established such as values in one field only being permitted for certain values in another field.

Once a conflict has been determined, the rules of rules database 6 are invoked to enable such conflicts to be resolved (step 32 in FIG. 2). The way in which the reconciliation between conflicting storage templates is resolved can vary from case to case.

If after all conflicts have been resolved there remain uninstantiated fields in storage specification 16 then, according to the rules database 6 these can be left blank, populated according to default rules in the rules database 6 (e.g. if no retention period is specified, keep for 6 years) or a query can be addressed to a user via a user interface for them to instantiate the field. Thus, a further rule in rules database 6 may be that un-instantiated field values in the final storage specification can be instantiated by the user. However, only non-conflicted values will be permitted. This can be ensured by, for instance, providing the user with a drop down selection of permitted values or determining for each user entry whether a conflict exists and, if so, rejecting the user entry.

If a conflict is identified in step 30 but according to rules database 6 there does not exist a conflict resolution rule, a user query is generated via a user interface.

Once any specification template conflicts have been resolved, a final storage specification 14 is generated for the document 10 by instantiating the relevant fields of the storage specification according to the output of the rules database 6 (step 34 in FIG. 2). The document 10 and associated storage specification 14 can then be output from the apparatus 2 and stored in document repository 16 (step 36 in FIG. 2).

The storage specification templates, and the final storage specification 16, can be documents based on an XML representation. Their structure is, in effect, predefined but the values can be instantiated according to the requirements of a particular application and storage system.

Referring to FIG. 3 of the drawings that follow, the document storage specification generator apparatus 2 is typically embodied in a computer apparatus 38 comprising a memory 40, a processor 42 a screen 44 and a peripheral input device 46 (e.g. a keyboard). A computer program (indicated schematically at 48) in memory 36 operates the computer apparatus 38 according to the present invention. The screen 44 and peripheral input device 46 act as a user interface. Queries are addressed to a user via screen 44 and the user can make inputs using peripheral input device 46.

In an alternative, simplified embodiment, the labels 12 may be used to generate storage specification fields that may be independent of predetermined storage specification templates.

Documents 10 and/or labels 12 associated therewith can be input via any suitable input channel e.g. from a hard drive, a data carrier (e.g. a CD-ROM), via the internet etc.

Elements of the computer apparatus may be located in separate computer nodes in a distributed electronic network such as the internet, a local area network or a wide area network.

Reference in this specification to a “database” does not require storage in a dedicated database application, though often this will be convenient, only that it be a repository for the relevant data.

Thus, embodiments of the present invention can provide fast and automatically generated storage specifications for documents having complex specification templates associated therewith and can reconcile associated conflicts therebetween.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A document storage specification generator apparatus for generating a storage specification for a document, the document having associated with it at least one storage label, the apparatus comprising a storage specification template database for determining storage specification templates according to storage labels associated with documents, a rules database comprising rules for resolving conflicts between conflicting storage specification templates and a storage specification generator for generating a storage specification for the document therefrom.

2. A document storage specification generator according to claim 1, in which the apparatus comprises a hierarchy database having a specification template hierarchy and rules database comprises hierarchy rules for reconciling storage specification template conflicts according to the relative storage specification hierarchy.

3. A document storage specification generator according to claim 1, in which the rules database comprises inter-label storage specification template conflict resolution rules.

4. A document storage specification generator according to claim 1, in which a storage specification template comprises a plurality of fields.

5. A document storage specification generator according to claim 4, in which the apparatus is configured whereby the rules database provides default entries for uninstantiated fields in the storage specification template.

6. A document storage specification generator according to claim 4, in which the apparatus is configured whereby if there is an uninstantiated field in the storage specification template a user query is referred to a user interface.

7. A document storage specification generator according to claim 1, in which the apparatus is configured whereby if the rules database determines that a conflict between storage specification templates exists, but that no rule is provided to reconcile the conflict, a user query is generated to a user interface.

8. A document storage specification generation method, for generating a storage specification for a document, the document having associated with it at least one storage label, the method comprising the steps of determining at least one storage specification field according to storage labels associated with documents, resolving conflicts between conflicting storage specification fields by applying rules from a rules database and generating a storage specification for the document therefrom.

9. A document storage specification generation method according to claim 8, in which the at least one storage specification field is of a storage specification template.

10. A document storage specification generation method according to claim 9, in which there is a hierarchy database having hierarchies of specification templates and the rules database comprises hierarchy rules for reconciling storage specification template conflicts according to the relative storage specification hierarchy.

11. A document storage specification generation method according to claim 10, in which the rules database comprises inter-label storage specification template conflict resolution rules.

12. A document storage specification generation method according to claim 11, in which the hierarchy rules are applied before the inter-label storage specification template rules.

13. A document storage specification generation method according to claim 9, in which a storage specification template comprises a plurality of fields.

14. A document storage specification generation method according to claim 13, in which the rules database provides entries for uninstantiated fields in the storage specification template.

15. A document storage specification generation method according to claim 13, in which if there is an uninstantiated field in the storage specification template a user query is referred to a user interface.

16. A document storage specification generation method according to claim 9, in which if it is determined that a conflict between storage specification templates exists, but that no rule is provided to reconcile the conflict, a user query is generated to a user interface.

17. A document storage specification generation method according to claim 9, in which a storage specification for the document is output and associated with the document.

18. (Cancelled)

19. (Cancelled)

20. A computer apparatus programmed to operate according to the method of claim 8.
